(19) United States
(12) Patent Application Publication
(10) Pub. No.: US 2009/0296244 A1
(43) Pub. Date: Dec. 3, 2009

(54) Surgical Mirror

(76) Inventor: Michael D. Baskett, Centreville, VA (US)

Correspondence Address: SHAWNA J. SHAW, 15151 STRATTON MAJOR CT., CENTERVILLE, VA, 20120, US

(21) Appl. No.: 12/128,139

(22) Filed: May 28, 2008

(51) Int. Cl. G02B 7/182

(52) U.S. Cl. 359/871; 359/838

(57) ABSTRACT

A surgical mirror assembly for facilitating observation of surgical procedures. The mirror assembly includes a holder and a mirror, wherein the mirror is coupled to the holder in an adjustable manner. Preferably, the holder includes a superior portion for resting on a patient surface adjacent to a surgical site and a medial portion for hanging at least partially in the surgical site; wherein the mirror is coupled to the superior and medial portions of the holder in an adjustable manner to improve a field of view of the surgical site. The mirror and mirror holder may be readily placed anywhere adjacent to the surgical site so as to improve the field of view for the assistant. As a result, an assistant may observe a reflected view of the surgical site as the surgeon works.

### BACKGROUND OF THE DISCLOSURE

1. Field of the Disclosure

The present disclosure relates generally to surgical accessories. More specifically, the present disclosure relates to a surgical mirror for improving the field of view of a surgical site.

2. Background of the Disclosure

Traditional open cholecystectomies (removal of the gall bladder) and splenectomies (removal of the spleen) are typically performed through an incision in the abdomen to allow a surgeon to directly access underlying organs. Such incisions may range anywhere from four to seven inches in length or more depending upon the particular patient. Today, although laparoscopic techniques have replaced many open procedures, such less invasive techniques are not always feasible. In some cases, laparoscopic surgeries end up being converted to open surgeries for various reasons. Some reasons for performing open surgeries include: limited or obscured laparoscopic field of view, abdominal peritoneal adhesions, extensive scar tissue from previous surgeries, planned bile duct exploration, high BMI, or unavailability of laparoscopic equipment. As a result, there remain many surgeries that are still performed using conventional open techniques.

During open surgery, surgical assistants help to keep the surgical site clear by holding organs out of the way using retractors and other medical instruments. For example, during cholecystectomies, an assistant may need to retract the liver or gall bladder out of the way as the surgeon works. Alternatively, during splenectomies, the assistant may need to retract the diaphragm or other tissues out of the way.

One common problem with open surgical procedures is that assistants have limited field of view due to the nature of the surgery, their position relative to the surgeon, etc. For example, in some cases, the surgeon's hands or head may block the field of view for assistants. Consequently, it is difficult to see what the surgeon is doing. However, for a procedure to be as efficient and effective as possible, an assistant needs to be aware of what the surgeon is currently doing in order to know what action to take next. For example, if the assistant is holding certain tissues out of the way, the assistant may need to manipulate the tissues in a certain direction so that the surgeon can advance to the next step. In addition, during critical steps of a procedure, it may be imperative that the assistant hold the tissue in a particular manner so that the surgeon does not inadvertently cut healthy tissue. However, if the assistant is unable to see what is happening, it is difficult to anticipate what the surgeon will do next or to effectively manipulate tissue in a critical manner. Sometimes one or more assistants end up crowding closely to the surgeon in order to view the surgical site. However, this is undesirable as such crowding hinders the surgeon, obscures the field of view for others, and/or causes instruments held by assistants to shift.

U.S. Pat. No. 4,138,083 to Spiegel discloses a demonstration mirror that exemplifies the general need to improve visualization of open surgical procedures. However, the disclosed device is primarily designed to allow a large number of people in a remote gallery to view a surgical site. As a result, the device requires relatively large dimensions. In addition, the device is also heavy, bulky, and awkward. Such a device is not designed for improving the field of view of an assistant in close proximity to the surgeon.

What is needed, therefore, is a simple adjustable mirror assembly for improving the field of view of an open surgical site so that an assistant can effectively see what the surgeon is currently doing. There is also a need for a surgical mirror assembly for observing a surgical site that is relatively small, inexpensive, and may be readily implemented. There is further a need in the art for a surgical mirror assembly for observing a surgical site that enables safer, more efficient, and more effective open surgical procedures.

### SUMMARY OF THE DISCLOSURE

The present disclosure overcomes drawbacks of the prior art by providing a surgical mirror assembly that improves the field of view of a surgical site for one or more assistants. An improved field of view is enabled by a small, adjustable surgical mirror assembly placed adjacent to or partially in a surgical site to reflect an unobstructed view of the surgical site as a surgeon works. The present disclosure also overcomes drawbacks of the prior art by providing a simple and inexpensive device for improving the field of view for an assistant in close proximity to a surgical site.

According to a preferred aspect, the disclosure provides a surgical mirror assembly for facilitating observation of surgical procedures, the mirror assembly comprising a holder and a mirror, wherein the mirror is coupled to the holder in an adjustable manner. Preferably, the holder includes a superior portion for resting on a patient surface adjacent a surgical site and a medial portion for hanging at least partially in the surgical site; wherein the mirror is coupled to the superior and medial portions of the holder in an adjustable manner to improve a field of view of the surgical site. As a result, an assistant using a retractor or other surgical instrument may observe a reflected view of the surgical site as the surgeon works. The mirror and holder may be placed anywhere adjacent to the surgical site so as to improve the field of view for the assistant. In addition, it is appreciated that the position of the mirror and holder may depend on the position of the surgeon and the assistant with respect to the surgical site. For example, if the surgeon's hands are straight out in front as he works, the mirror may be placed behind, or to the side, of the surgeon's hands so as to reflect what is taking place in between without interfering with the procedure. By positioning the mirror slightly in the surgical site, a view from underneath the surgeon's hands or arms may also be obtained.

In embodiments, the superior and medial portions of the holder include one or more coupling mechanisms (such as hooks, tabs, etc.) for supporting the mirror. By providing a plurality of coupling mechanisms, the elevation and angle of the mirror may be readily adjusted to provide an optimal field of view. It is appreciated that the coupling mechanisms are located on an outer portion of the holder and therefore need not come into direct contact with the surgical site. According to further embodiments, the mirror includes a medial rod coupled to a bottom portion of the mirror and a superior rod coupled to a top rear portion of the mirror. In operation, the medial rod may be coupled to the medial portion of the holder and the superior rod coupled to the superior portion of the holder. In embodiments, the superior portion of the holder also includes a mechanism for securing the holder to an opening of a fenestrated surgical drape adjacent to the surgical site.

One advantage of the disclosed surgical mirror assembly is its ability to improve the field of view for an assistant. Thus, the need for assistants to crowd closely to the surgeon to view the surgical site is avoided. Moreover, an assistant can view what the surgeon is doing and thus be aware of what action is required, and when.

Another advantage of the disclosed surgical mirror assembly is its ability to be quickly and easily adjusted to improve field of view. As a result, if the surgeon or assistant change positions, the mirror may be easily readjusted without interfering with the surgical procedure.

Yet another advantage the disclosed surgical mirror assembly is that it is small, simple, and inexpensive and thus may be readily implemented.

A further advantage of the disclosed surgical mirror assembly is that it may be readily sterilized for reuse. Alternatively, the surgical mirror assembly may be designed for single use.

### BRIEF DESCRIPTION OF THE DRAWINGS

FIG. 1 shows a side view of a surgical mirror assembly including a holder and a mirror according to a preferred embodiment of the present disclosure.

FIG. 2a shows a top view of the mirror holder according to one exemplary embodiment of the present disclosure.

FIG. 2b shows a top view of the mirror holder according to another exemplary embodiment of the present disclosure.

FIG. 2c shows a top view of the mirror holder according to yet another exemplary embodiment of the present disclosure.

FIG. 3a shows a side view of a mirror according to an exemplary embodiment of the present disclosure.

FIG. 3b shows a rear view of a mirror according to an exemplary embodiment of the present disclosure.

### DETAILED DESCRIPTION OF VARIOUS EMBODIMENTS OF THE DISCLOSURE

Reference will now be made in detail to various exemplary embodiments of the disclosure, examples of which are illustrated in the accompanying drawings. The following detailed description describes certain embodiments of the disclosure, and should not be considered as limiting the disclosure to those embodiments.

The present disclosure offers a solution to problems associated with limited fields of view during surgical procedures. The solution is a surgical mirror assembly including a holder for placement adjacent to and/or partially in a surgical site, and a mirror coupled to the holder in an adjustable manner. The present disclosure thus provides improved field of view capabilities for assistants in close proximity to the surgical site without needing to crowd around the surgeon. Of the many other advantages provided by the device, it is inexpensive, is simple and easy to use, may be readily sterilized, and improves safety, efficiency and performance of surgical procedures.

Turning now to the figures, which depict various exemplary embodiments of the disclosure, a surgical mirror assembly 10 is shown that improves the field of view of a surgical site 18.

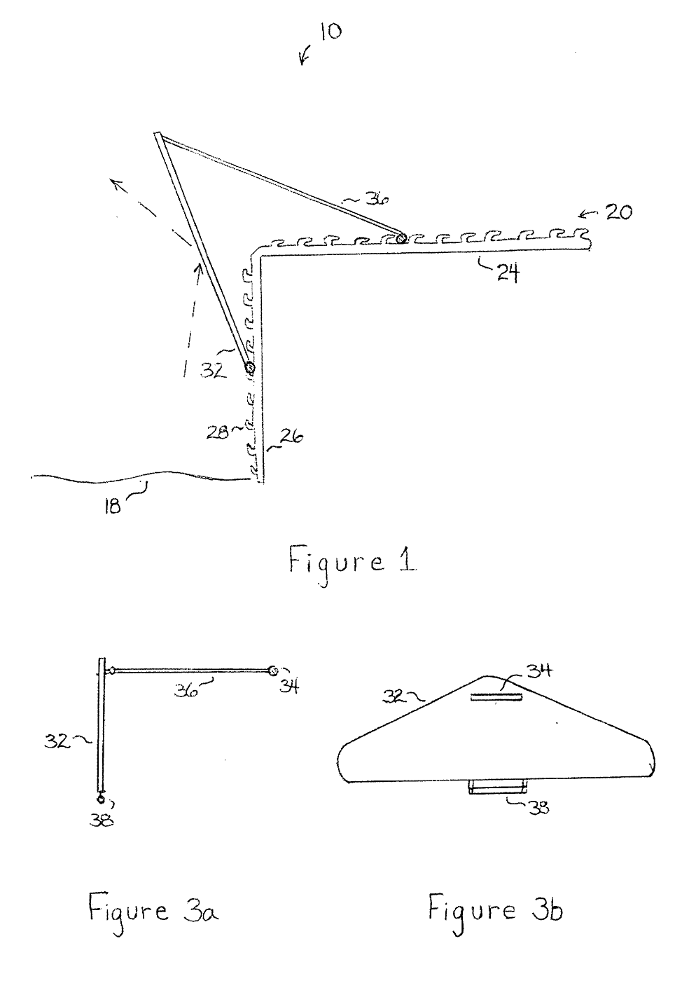

As illustrated in FIG. 1, the surgical mirror assembly 10 comprises a mirror 32 adjustably coupled to a holder 20. The mirror 32 may be adjusted with respect to the holder 20 to reflect a view (depicted by dashed arrows) of a surgical site 18. As shown, the holder 20 includes a superior portion 24 and a medial portion 26. Preferably, the superior portion 24 is adapted to rest on a patient surface adjacent to a surgical site 18. In addition, the medial portion 26 may be adapted to hang at least partially within the surgical site 18 to allow a coupled mirror 32 to reflect an unobstructed view of the surgical site 18. Although the superior and medial portions 24 and 26, respectively, are shown at right angles to one another, it is understood that other angles are possible. In embodiments, the holder 20 may be composed of a flexible or pliable material such that the superior and medial portions 24 and 26 may be conformed to the surface of the patient and/or surgical site.

It is appreciated that the holder 20 may be comprised of metal, stainless steel, plastic, rubber, and/or any other material suitable to perform the functions disclosed herein. In embodiments, the holder 20 is composed of stainless steel so as to be durable and easily sterilized. In other embodiments, the holder 20 is flexible so as to gently conform to the patient surface and/or surgical site 18. Examples of flexible or conformable materials include, but are not limited to: rubbers, plastics, shape memory materials, or the like. The holder 20 may be designed to have various sizes or shapes depending upon the type of surgery or application of use. For example, larger holders 20 may be required for obese patients who tend to have thicker abdominal tissue layers. Accordingly, the holder 20 may have any dimensions suitable for performing the functions disclosed herein.

In embodiments, the superior portion 24 and medial portions 26 further comprise a plurality of coupling mechanisms 28 such as hooks, tabs, or the like, for adjustably supporting the mirror 32. By providing a plurality of coupling mechanisms 28 on the superior and medial portions 24 and 26, respectively, the elevation and angle of the mirror 32 may be readily adjusted to provide an optimal field of view for an assistant in proximity to the surgical site 18. It is further appreciated that the coupling mechanisms 28 are located on the outer portion of the holder 20 and therefore need not come into direct contact with the patient.

In addition, the location of the mirror 32 and holder 20 may depend on the position of the surgeon and the assistant with respect to the surgical site 18. For example, if the surgeon's hands are straight out in front as he works, the mirror 32 may be effectively placed behind, or to the side, of the surgeon's hands so as to reflect what is taking place in between without interfering with the procedure.

The mirror 32 may be comprised of various materials, including polished metal, stainless steel, plastic, glass, or the like. For example, polished stainless steel mirrors for surgical devices are disclosed in U.S. Pat. No. 5,349,943 to Ruiz. The mirror 32 may further be comprised of multiple layers as will be appreciated by those skilled in the art. Moreover, possible mirror configurations include, but are not limited to: rectangular, circular, oval, parabolic, and triangular shapes.

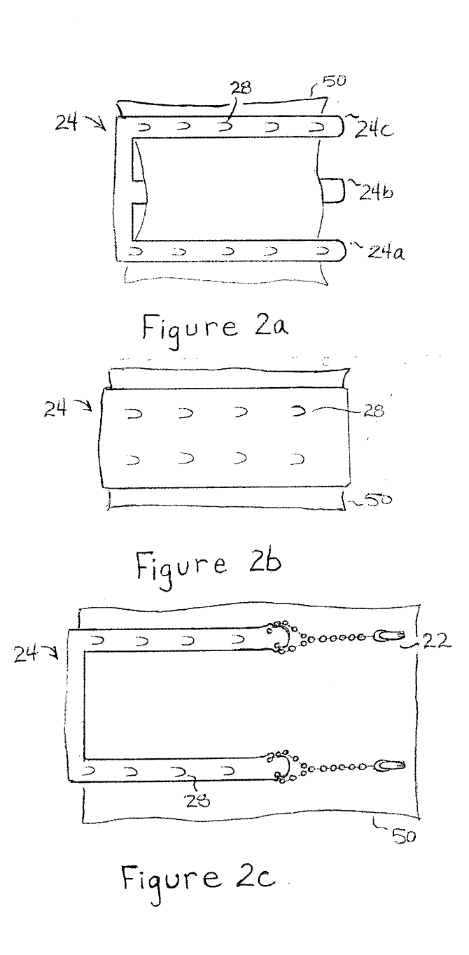

In embodiments, the superior portion 24 of the holder 20 may additionally be secured to a surgical drape to provide extra stability for the surgical mirror assembly 10. For example, FIG. 2a depicts a top view of the superior portion 24 adapted to be secured to an opening of a fenestrated surgical drape 50. In this embodiment, the superior portion 24 comprises a plurality of “arms,” or tines, 24a-c for securing the holder 20 to an adjacent surgical drape 50 as shown. It is appreciated that the arms may be designed with any dimensions sufficient to support a mirror 32 (shown in FIG. 1) in an upright manner and to perform the functions disclosed herein. Although three arms 24a-c are illustrated in FIG. 2a, it is understood that more, or less, arms may be used. Preferably, arms 24a and c also include a plurality of coupling mechanisms 28 for adjustably supporting the mirror 32. However, it should be understood that the number or arrangement of the coupling mechanisms 28 may vary depending upon the particulars of the application and are not intended to be limited to the configuration shown.

FIG. 2b depicts a top view of a “continuous” superior portion 24 adapted to stably rest on a patient surface (for example, directly on tissue or on a surgical drape) according to another exemplary embodiment of the present disclosure. To keep from slipping, the superior portion 24 may include slip-resistant or high friction materials. Additionally or alternatively, the superior portion 24 may be secured to a drape 50 using magnets, hook and loop fasteners, tape, or the like. It is further appreciated that the superior portion 24 may be designed with any dimensions sufficient to support the mirror 32 in an upright manner and to perform the functions disclosed herein. It should also be understood that the number or arrangement of the coupling mechanisms 28 may vary depending upon the particulars of the application and are not intended to be limited to the configuration shown.

FIG. 2c depicts a top view of a superior portion 24 adapted to be secured to an opening of a fenestrated surgical drape 50 according to yet another exemplary embodiment of the present disclosure. As shown, one or more clips 22 are used to provide additional support or stability for the superior portion 24. Such clips 22 include e.g., spring clips, alligator clips, or any conventional clip suitable for surgical applications. As shown, each clip 22 is coupled at one end to the superior portion 24, and the “jaws” used to grasp a portion of the surgical drape 50. The clips 22 may be coupled to the superior portion 24 e.g., by inserting a conventional metal ball chain into slots on one or more arms thereof as shown. Alternatively, clips 22 may be coupled directly to the superior portion 24 e.g., by soldering, welding, gluing, epoxying, or the like. It should also be understood that the coupling mechanisms 28 are not limited to the arrangement shown and that the number or configuration of coupling mechanisms 28 may vary depending upon the particulars of the application.

Although not shown in FIGS. 2a-c, the medial portion 26 of holder 20 may also comprise various configurations including a continuous portion, one or more arms, etc. similar to superior portion 24. Preferably, the medial portion 26 is designed with any dimensions suitable for performing the functions disclosed herein.

FIG. 3a depicts a side view of the mirror 32. As shown in the figure, a superior rod 34 (shown in cross section) is coupled to a rear surface of the mirror 32 via one or more supports 36. In embodiments, the support 36 comprises an arm pivotally coupled to the mirror 32 using e.g., a hinge, ball joint, or other equivalent device. For example, by using a ball-joint, rotation of the mirror may be achieved in two or more directions. In other embodiments, the support 36 is a metal ball chain, or other flexible device for supporting the mirror 32. Also shown in FIG. 3a, is a medial rod 38 (shown in cross section) coupled to a bottom portion of the mirror 32. In embodiments, the medial rod 38 is also coupled to the mirror 32 using one or more hinges, ball joints, etc.

FIG. 3b depicts a rear view of the mirror 32. As shown in FIG. 3b, the medial rod 38 is longitudinally disposed adjacent a bottom portion of the mirror 32, and the superior rod 34 is coupled to the top rear portion of mirror 32 via support 36 (not shown).

In operation, the mirror 32 is adjustably coupled to the holder 20 by securing the medial rod 38 to the medial portion 26 of the holder, and securing the superior rod 34 to the superior portion 24 of the holder 20. In embodiments, the rods 38 and 34 are releasably coupled to the holder 20 e.g., by hooks, tabs, or any other equivalent coupling mechanism 28. Thus, if the assistant needs to adjust the mirror 32, the superior rod 34, medial rod 38, or both, may be readily engaged with a different coupling mechanism 28 to adjust the viewing angle. By providing a plurality of coupling mechanisms 28 on the superior and medial portions 24 and 26, respectively, the elevation and angle of the mirror 32 can be adjusted to provide an optimal field of view. In addition, by using e.g., ball joints to couple the mirror 32 to support 36 and/or medial rod 38, the angle of the mirror 32 may be adjusted in two or more directions.

In embodiments, the mirror 32 is comprised of: polished metal, stainless steel, plastic, glass, or the like. It is further understood that the mirror 32 may be comprised of a plurality of layers, including various protective coatings. Such layers may be disposed on the mirror surface e.g., by vapor deposition or other conventional manufacturing techniques. Examples of protective coatings include, but are not limited to: anti-glare or anti-reflective coatings, anti-fogging coatings, and scratch-resistant coatings, as will be appreciated by those skilled in the art. In some cases, scratch-resistant coatings may be desirable to protect from damage by surgical instruments. Preferably, the coatings are able to withstand chemicals, high temperatures, high pressures, etc. used for sterilization. Alternatively, the materials are suitable for one-time use and are therefore disposable.

The size and shape of the mirror 32 may vary depending upon the intended surgical application. Preferably, the dimensions of the mirror 32 are sufficiently small to fit at least partially within the surgical site while providing an improved field of view for one or more assistants. In embodiments, the mirror is designed to be planar or curved. For example, a planar mirror 32 can be used to provide an image of a surgical site with a one-to-one ratio. In another example, a slightly concave or parabolic mirror 32 can be used to provide a wider field of view of the surgical site. It is appreciated that the mirror 32 may further be designed to provide other magnification ratios as will be appreciated by those skilled in the art. Moreover, possible mirror shapes include, but are not limited to: rectangular, circular, oval, parabolic and triangular.

It can be seen from the above discussion that the disclosed surgical mirror is able to provide improved visibility of a surgical site for one or more assistant. Such capabilities are enabled by an adjustable mirror placed adjacent to or slightly in a surgical site for reflecting a view of the site as a surgeon works. Preferably, as discussed above, the mirror can be adjusted in elevation, angle, and/or rotation to provide an optimal field of view.

By providing improved field of views, the surgical mirror assembly 10 of the present disclosure can improve speed and accuracy of open surgical procedures. As a result, the surgical mirror is able to provide safer and more effective results while additionally saving time by enabling an assistant to anticipate a next required course of action.

The foregoing disclosure of the preferred embodiments of the present disclosure has been presented for purposes of illustration and description. It is not intended to be exhaustive or to limit the disclosure to the precise forms disclosed. Many variations and modifications of the embodiments described herein will be apparent to one of ordinary skill in the art in light of the above disclosure. While not limited to any particular use, it is envisioned that the surgical mirror assembly 10 is advantageous for use in abdominal surgeries such as gall bladder surgeries, splenectomies, etc. However, the surgical mirror assembly 10 may be used in other surgical procedures such as prostate surgeries, urinary bladder resection, and more. In addition to improving fields of view for surgical assistants, the surgical mirror assembly 10 may also be used to improve the field of view for additional surgeons or other observers in close proximity to the surgical site. It is further envisioned that the size and shape of the surgical mirror assembly 10 may be varied depending upon the type of surgery or application of use. For example, the holder 20 and/or mirror 32 may be designed to be larger for obese patients, and smaller for younger patients. In embodiments, the holder 20 may be composed of a flexible or pliable material so that it may be conformed to the patient and/or surgical site for good surface contact. Moreover, the shape of the surgical mirror may assume various shapes depending upon the type or surgery or application. The disclosed surgical mirror assembly 10 may further be used with any suitable light source to provide improved illumination of the surgical site. Accordingly, the scope of the disclosure is to be defined only by the claims appended hereto, and by their equivalents.

1. A surgical mirror assembly for facilitating observation of surgical procedures, the mirror assembly comprising:
a holder including:
a superior portion adapted to rest on a patient surface, and
a medial portion adapted to hang at least partially in a surgical site; and
a mirror, wherein the mirror is coupled to the superior and medial portions of the holder in an adjustable manner so as to improve a field of view of the surgical site.

2. The surgical mirror assembly of claim 1, wherein the mirror further includes a medial rod coupled to a bottom portion of the mirror and a superior rod coupled to a top rear portion of the mirror, such that the medial rod may be coupled to the medial portion of the holder and the superior rod may be coupled to the superior portion of the holder.

3. The surgical mirror assembly of claim 2, wherein the superior rod is pivotally coupled to the top rear portion of the mirror.

4. The surgical mirror assembly of claim 1, wherein the superior and medial portions of the holder include one or more coupling mechanisms for supporting the mirror.

5. The surgical mirror assembly of claim 4, wherein the one or more coupling mechanisms correspond to one or more hooks.

6. The surgical mirror assembly of claim 4, wherein the one or more coupling mechanisms correspond to one or more tabs.

7. The surgical mirror assembly of claim 1, wherein the holder superior portion includes a means for securing the holder to a surgical drape.

8. The surgical mirror assembly of claim 7, wherein the means for securing includes a plurality of arms.

9. The surgical mirror assembly of claim 7, wherein the means for securing includes a plurality of clips.

10. The surgical mirror assembly of claim 1, wherein the holder is conformable.

11. The surgical mirror assembly of claim 1, wherein the mirror is adjustably coupled to the holder such that the mirror may be adjusted in elevation, angle and/or rotation.
